(19) United States
(12) Patent Application Publication
(10) Pub. No.: US 2024/0265455 A1
(43) Pub. Date: Aug. 8, 2024

(54) METHOD AND SYSTEM FOR DETECTING A CHANGE OF OWNERSHIP OF A CONNECTED VEHICLE

(71) Applicant: OTONOMO TECHNOLOGIES LTD., Herzeliya Pituach (IL)

(72) Inventors: Tomer RAANAN, Ganey Tikva (IL); Yosef Haim ITZKOVICH, Raanana (IL)

(73) Assignee: OTONOMO TECHNOLOGIES LTD., Herzeliya Pituach (IL)

(21) Appl. No.: 18/164,929

(22) Filed: Feb. 6, 2023

(51) Int. Cl. G06Q 40/06

(52) U.S. Cl. CPC G06Q 40/06

(57) ABSTRACT

A method and a system for detecting a change of ownership of a connected vehicle are provided here. The method may include: obtaining, a plurality of automotive data records associated with connected vehicles having respective drivers; creating, responsive to an explicit indication of a driver association of a specific driver, to a specific connected vehicle of the connected vehicles, a unique driver profile which includes driver parameters being a subset of the automotive data records that are associated with an identity of the specific driver; learning, over a training stage, values of the driver parameters representative of the specific driver; monitoring, over a detection stage, values of the driver parameters of the specific driver, to detect an event of change of ownership of said specific driver related to the specific vehicle, in view of the learnt and monitored driver parameters, and in view of change of ownership criteria.

### FIELD OF THE INVENTION

The present invention relates generally to the field of processing data features, and more particularly to processing automotive data records obtained from connected vehicles.

### BACKGROUND OF THE INVENTION

Prior to setting forth the background of the invention, it may be helpful to provide definitions of certain terms that will be used hereinafter.

The term “connected vehicle” as used herein is defined as a vehicle such as a car or any other vehicle such as an aerial vehicle that is equipped with any form of wireless network connectivity access, and usually also with a wireless local area network. This allows the connected vehicle to share internet access with other devices both inside as well as outside the vehicle.

The term “data marketplace” or “data market” as used herein is defined as an online platform that enables a plurality of users (subscribers) to access and consume data. Data marketplaces typically offer various types of data for different markets and from different sources. Common types of data consumers include business intelligence, financial institutions, demographics, research and market data. Data types can be mixed and structured in a variety of ways. Data providers may offer data in specific formats for individual clients.

Data consumed in these marketplaces may be used by businesses of all kinds, fleets, business and safety applications and many types of analysts. Data marketplaces have proliferated with the growth of big data, as the amount of data collected by municipalities and smart cities, businesses, websites and services has increased, and all that data has become increasingly recognized as an asset.

Controllers of personal data must put in place appropriate technical and organizational measures to implement the data protection principles. Business processes that handle personal data must be designed and built with consideration of the principles and provide safeguards to protect data and use the highest-possible privacy settings by default, so that the data is not available publicly without explicit, informed consent, and cannot be used to identify a subject without additional information stored separately.

A processor of personal data must clearly disclose any data collection, declare the lawful basis and purpose for data processing, and state how long data is being retained and if it is being shared with any third parties. Data subjects have the right to request a portable copy of the data collected by a processor in a common format, and the right to have their data erased under certain circumstances, a concept also known as the right to be forgotten.

The term “data anonymization” as used herein is defined as type of information sanitization whose intent is privacy protection. It is the process of either encrypting or removing personally identifiable information from data sets, so that the people and other entities whom the data describe remain anonymous.

In the connected vehicles domain, vehicles send automotive data to the cloud, and this data is used by other services in accordance with a consent made by the driver. In order to comply with various privacy regulations, data marketplaces need to link a driver entity with a vehicle entity to let the driver permission to control the vehicle and the data. At the same time, it is desirable to find a way to automatically detach the vehicle from the driver in a case that the vehicle changes ownership, hereinafter referred to as “driver detachment” or more precisely “change of ownership” of a connected vehicle.

Detecting a change of ownership of a connected vehicle is of great importance and affects privacy issues since a connected vehicle is configured to share its data according to driver consent. When a vehicle changes ownership it shall continue to share the data of the vehicle, now owns by the new driver, possibly without their consent, unless an event of driver detachment has been detected thereby revoking the consent of the former driver for data sharing.

### SUMMARY OF THE INVENTION

According to some embodiments of the present invention, a method and system for deducing that an event of a change of ownership of a connected vehicle has occurred are provided herein.

The attaching or association of a driver with a connected vehicle is a complicated process. This is due to the fact that a driver needs to prove that they own the connected vehicle. Therefore, it is desirable to apply the driver-vehicle association process as seldom as possible.

Therefore, in accordance with some embodiments of the present invention, it is desirable to apply the driver association with a specific connected vehicle process only once and provide an implicit manner of detecting an event of a change of ownership of a connected car, without the need for the driver to explicitly indicate a change of ownership event or actively revoking their consent for using of their data.

According to some embodiments of the present invention, method of detecting a change of ownership in a connected vehicle, the method comprising: obtaining, from a plurality of data sources, a plurality of automotive data records associated with connected vehicles associated with respective drivers; creating, responsive to an explicit indication of an association of a specific driver of the respective drivers, with a specific connected vehicle of the connected vehicles, a unique driver profile comprising driver parameters being a subset of the automotive data records that are associated with an identifier of said specific driver; learning, over a training stage, values of said driver parameters representative of said specific driver; and detecting an event of change of ownership of said specific driver of said specific vehicle, by monitoring values of said driver parameters of said specific driver over time, and comparing the values of said driver parameters to the values of said driver parameters obtained by said learning, in view of predefined change of ownership criteria.

According to some embodiments of the present invention, the aforementioned method may be implemented over an electronic marketplace for automotive data as a server or as a non-transitory computer readable medium.

These additional, and/or other aspects and/or advantages of the present invention are set forth in the detailed description which follows.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating an architecture of a marketplace server for managing data relating to connected cars in accordance with embodiments of the present invention;

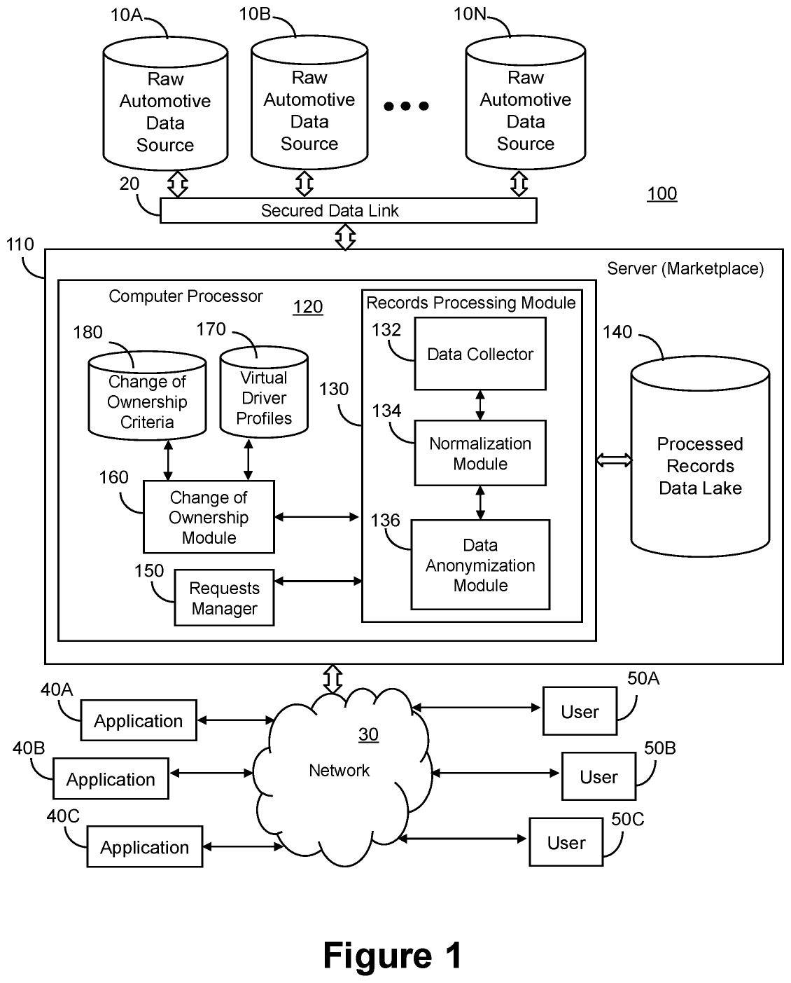

FIG. 2 is a high-level flowchart illustrating a method in accordance with some embodiments of the present invention; and

FIG. 3 is a high-level flowchart illustrating another method in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

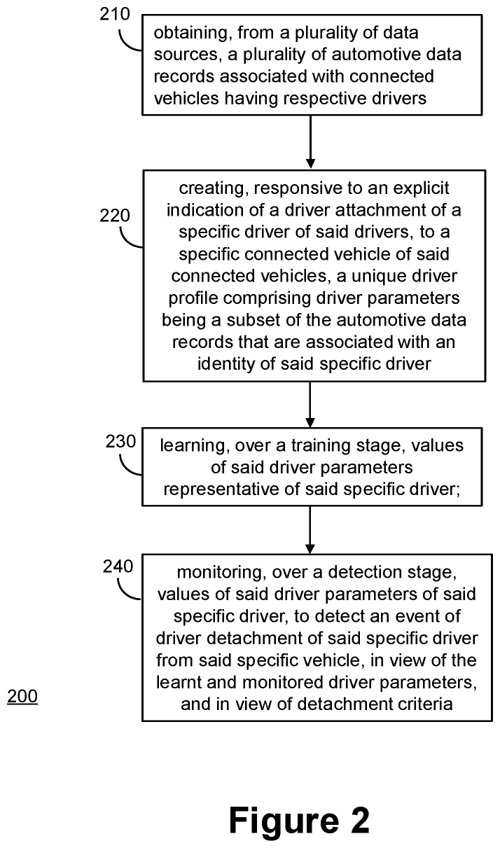

FIG. 2 is a block diagram illustrating non-limiting exemplary architecture 100 of a marketplace server for aggregating automotive data as well as users consent for a regulated consumption of the automotive data, in accordance with embodiments of the present invention.

The system may include: a server 120 configured to obtain a plurality of automotive data relating to connected vehicles originated from a plurality of data sources 110. System 100 may include a server 110 implementing the data marketplace and connected via network 30 to a plurality of users 50A-50C (e.g., drivers who are the data owners). Vehicle related data, possibly obtained from various sensors on the connected vehicles of users 50A-50C, may be stored in raw format on a plurality of raw automotive data sources 10A-10N and may be accessed by server 110 via a secured data link 20. Server 110 may include a records processing module 130 implemented by a computer readable code running on computer processor 120. Records processing module 130 may include a data collector 132, a normalization module 134 and a data anonymization module 136 that are configured to collect, normalize and anonymize respectively the data arriving from the plurality of automotive data sources 10A-10N, thus creating a processed records data lake 160 storing vehicle related data. The processed automotive data records are being consumed and used by various data consumers such as applications 40A-40C connected to server 110 via network 30, responsive to various requests for services made by plurality of users 50A-50C. These requests may be made directly by users 50A-50C to applications 40A-40C over network 30 and via requests manager 150.

In accordance with some embodiments of the present invention, server 110 may include a change of ownership module 160 implemented by a computer code running on computer processor 120 and configured to detect a driver in order to achieve this, change of ownership module 160 may be configured to: create, responsive to an explicit indication of a driver association of a specific driver of said drivers, to a specific connected vehicle of said connected vehicles, a unique driver profile comprising driver parameters being a subset of the automotive data records that are associated with an identity of said specific driver; learn, over a training stage, values of said driver parameters representative of said specific driver; and monitor, over a detection stage, values of said driver parameters of said specific driver, to detect an event of driver detachment of said specific driver from said specific vehicle, in view of the learnt and monitored driver parameters, and in view of detachment criteria.

According to some embodiments of the present invention, a server 110 capable of detecting an event of change of ownership may include: a records processing module 130 configured to obtain, from a plurality of data sources, a plurality of automotive data records associated with connected vehicles having respective drivers; and a change of ownership module configured to: create, responsive to an explicit indication of a driver association of a specific driver of said drivers, to a specific connected vehicle of said connected vehicles, a unique driver profile comprising driver parameters being a subset of the automotive data records that are associated with an identity of said specific driver; learn, over a training stage, values of said driver parameters representative of said specific driver; and monitor, over a detection stage, values of said driver parameters of said specific driver, to detect an event of driver detachment of said specific driver from said specific vehicle, in view of the learnt and monitored driver parameters, and in view of detachment criteria.

According to some embodiments of the present invention, wherein said explicit indication of a driver association is achieved based on an in-car infotainment system indicating that said specific driver is in said specific vehicle.

According to some embodiments of the present invention, wherein said driver parameters comprise at least: a home location, a work location, and a media access control (MAC) address of a blue tooth (BT) circuitry within a mobile phone of said specific driver.

According to some embodiments of the present invention, said detachment criteria comprise an indication that: a home location, a work location, and a mobile phone of said specific driver have been changed simultaneously.

According to some embodiments of the present invention, wherein said detachment criteria comprise a simultaneous change in said home location, said work location, and said MAC address of a said BT.

According to some embodiments of the present invention, wherein said unique driver profile comprises a virtual profile of said specific driver and wherein said detection of an event of change of ownership of said specific driver from said specific vehicle, is based on a difference, beyond a predefined threshold, between the virtual profile of said specific driver and the actual measurements of said driver parameters.

According to some embodiments of the present invention, change of ownerships module 160 monitors virtual fingerprint of the driver over time and if and when it changes—there is detachment otherwise no detachment occurred. The virtual fingerprint can be based on several heuristics and or biometric data associated with the driver.

FIG. 2 is a high-level flowchart illustrating non-limiting exemplary method in accordance with embodiments of the present invention. A method 200 of detecting an event of driver detachment may include the following steps: obtaining, from a plurality of data sources, a plurality of automotive data records associated with connected vehicles having respective drivers 210; creating, responsive to an explicit indication of a driver association of a specific driver of said drivers, to a specific connected vehicle of said connected vehicles, a unique driver profile comprising driver parameters being a subset of the automotive data records that are associated with an identity of said specific driver 220; learning, over a training stage, values of said driver parameters representative of said specific driver 230; monitoring, over a detection stage, values of said driver parameters of said specific driver, to detect an event of driver detachment of said specific driver from said specific vehicle, in view of the learnt and monitored driver parameters, and in view of detachment criteria 240.

In accordance with some embodiments of the present invention, a method may include a step of: obtaining a plurality of features using machine learning (for example) and try to learn patterns and trends relating to each driver. (e.g., how many time left home per week; stops etc.)

By learning behavioral pattern and it is possible to calculate a confidence level associated with the detection of the driver detachment event.

For example, embodiments of the present invention may detect driver detachment at a confidence level of 50% and as a result the system may start reducing data distribution (start with locations) then by keep monitoring and next time the data is checked (e.g. in a week) it is possible to find out confidence level is up to 70% and then the system further degrades the data (e.g. amount of data features or safety related—air bags, engine failure). Finally, if next check the confidence level is over 90% then the system cut the data flow altogether.

Advantageously the aforementioned mechanism may be GDPR compliant in the sense of “right to be forgotten” that is initiated as soon as driver detachment has been duly detected.

Only after the 30-days of the GDPR requirement (“duty to erase”) there will be limited access to the data, possibly in accordance with the confidence level as explained above.

Thereafter, the driver is checked in order to authenticate. If no authorization fails—the system gradually degrades data. if for reasonable amount of time (e.g., 30 days) no feedback—the system cuts off the data (by way of caution). The reasonable amount of time can be set again based on the confidence level the driver detachment was detected.

In accordance with some further embodiments of the present invention, change of ownership module 150 implemented by a computer code running on computer processor 120 may be further configured to detect a change of ownership and invoke a gradual restriction over time of access to data services modules 140 associated with data related to the vehicle from which the driver has detached. In order to achieve this, change of ownership module 150 may be configured to obtain a plurality of measurements from a vehicle; derive a pattern of driver-vehicle interaction based on the obtained measurements; and apply a decision function to the pattern, to yield a detection of driver detachment with a respective level of confidence. driver detachment module 150 is further configured to repeating the obtaining, deriving, and applying steps, wherein for each detected level of confidence, gradually reducing, over time, an access to the processed automotive data.

It is understood that the aforementioned gradual reduction of access to the processed automotive data can be either to data consumers (e.g., services or drivers) or data processors (e.g. custodians, transformer, providers, and the like).

According to some embodiments of the present invention, change of ownership module 160 may be configured to obtain plurality of features using machine learning (for example) and try to learn patterns and trends relating to each driver. (for example, how many times a driver left home per week; number of stops and the like.)

According to additional embodiments of the present invention, change of ownership module 160 may be configured to learn a routine pattern of the driver-vehicle interaction and thus can come up with a confidence level associated with the detection of the change of ownership event.

According to some embodiments of the present invention, change of ownership module 160 may detect change of ownership at a confidence level of 50% and thereafter it starts reducing data distribution, start with locations for instance.

Then, according to some embodiments of the present invention, change of ownership module 160 may be configured to keep monitoring and next time we check (e.g. in a week) and if it has been found confidence level up to 70% then change of ownership module 160 further degrades the data (e.g. amount of data features or safety related—air bags, engine failure). Finally, if on a next check by change of ownership module 160 the confidence level is over 90% then change of ownership module 160 cut the data flow altogether.

Advantageously, change of ownership module 160 renders marketplace serve 110 GDPR compliant in the sense of “right to be forgotten” that is initiated as soon as change of ownership has been detected. Only after the 30-days of the GDPR requirement (“duty to erase”) there will be limited access to the data, possibly in accordance with the confidence level as explained above.

In addition, change of ownership module 160 may initiate driver authentication. If no authorization fails—change of ownership module 160 gradually degrades data access. if for reasonable amount of time (e.g. 30 days) there is still no feedback then change of ownership module 160 may cut off the data (by way of caution). The reasonable amount of time can be set again based on the confidence level we detected the driver detachment.

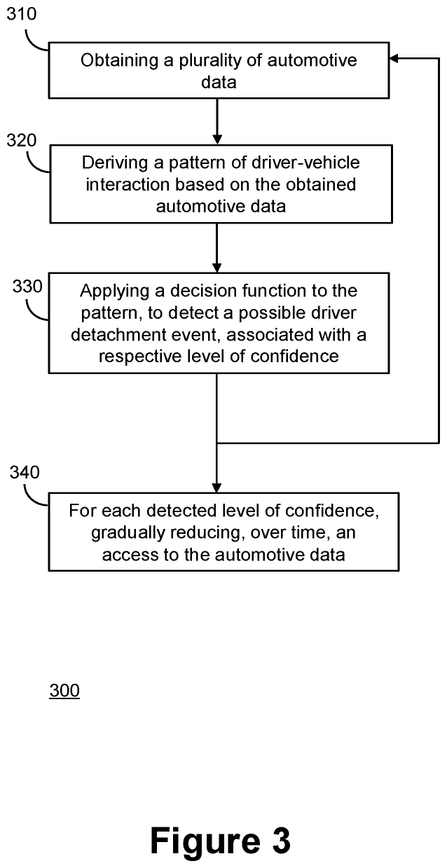

FIG. 3 is a high-level flowchart illustrating non-limiting exemplary method in accordance with embodiments of the present invention. A method 300 for detecting a change of ownership, invoking a gradual restriction over time of access to data services is provided herein. Method 300 may include the following steps: obtaining a plurality of automotive data associated with connected vehicles 310; deriving a pattern of driver-vehicle interaction based on the obtained automotive data 320; applying a decision function to said pattern, to yield a detection of change of ownership from a specific vehicle with a respective level of confidence 330; and repeating said obtaining and said applying, wherein for each detected level of confidence, gradually reducing, over time, an access to the automotive data associated with the specific vehicle 340.

It should be noted that methods 200 and 300 according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the methods according to embodiments of the present invention, a computer processor may receive instructions and data from a read-only memory or a random-access memory or both. At least one of the aforementioned steps may be performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of detecting a change of ownership in a connected vehicle, the method comprising:
obtaining, from a plurality of data sources, a plurality of automotive data records associated with connected vehicles associated with respective drivers;
creating, responsive to an explicit indication of an association of a specific driver of the respective drivers, with a specific connected vehicle of the connected vehicles, a unique driver profile comprising driver parameters being a subset of the automotive data records that are associated with an identifier of said specific driver;
learning, over a training stage, values of said driver parameters representative of said specific driver; and
detecting an event of change of ownership of said specific driver of said specific vehicle, by monitoring values of said driver parameters of said specific driver over time and comparing the values of said driver parameters to the values of said driver parameters obtained by said learning, in view of predefined change of ownership criteria.

2. The method according to claim 1, wherein said explicit indication of a driver association comprises obtaining from an in-vehicle infotainment system an indication that said specific driver is located within said specific vehicle.

3. The method according to claim 1, wherein said change of ownership criteria comprise an indication that: a home location, a work location, and a mobile phone of said specific driver have been changed simultaneously.

4. The method according to claim 1, wherein said driver parameters comprise at least one of: a home location, a work location, and a media access control (MAC) address of a Bluetooth (BT) circuitry of a mobile phone linked to said specific driver.

5. The method according to claim 4, wherein said change of ownership criteria comprise a simultaneous change in said home location, said work location, and said MAC address of a said BT circuitry.

6. The method according to claim 1, wherein said unique driver profile comprises a virtual profile of said specific driver and wherein the detection of the event of the change of ownership is further based on a difference, beyond a predefined threshold, between the virtual profile of said specific driver and the values of said driver parameters of said specific driver over time.

7. The method according to claim 1, wherein the detecting of the event of change of ownership is associated with one or more respective levels of confidence.

8. The method according to claim 7, further comprising providing the respective drivers with data services related to said automotive data records.

9. The method according to claim 8, wherein said data services comprises: anonymizing, normalizing, and scoring of said automotive data records and are carried out by an automotive data marketplace implemented on a server.

10. The method according to claim 8, wherein said data services are automotive data services carried out by a plurality of client applications associated with an automotive data marketplace implemented on a server.

11. The method according to claim 8, further comprising gradually reducing, over time, an access to the data services related to the automotive data records associated with the specific driver, based on the one or more respective levels of confidence.

12. The method according to claim 9, further associating one or more thresholds with the respective levels of confidence, wherein each of the thresholds is associated with a further restriction of access to said data services.

13. The method according to claim 9, further comprising applying a full restriction of access to said data services, upon lapsing of a predefined statutory period compliant with privacy regulations.

14. The method according to claim 9, further comprising applying a full restriction of access to said data services, upon an explicit detection of a consent revocation of said specific driver.

15. The method according to claim 1, wherein said unique driver profile further comprises interaction parameters indicating an interaction of the specific driver with the specific connected vehicle.

16. The method according to claim 15, wherein the interaction parameters comprises at least one of: road behavior, cumulative drive in a month, a number of times ignition switch is turned on during a drive, duration of drives, and duration and frequency of stops within a drive.

17. The method according to claim 1, wherein said learning, over the training stage, comprises training a machine learning model using a stream of said driver parameters representative of said specific driver, wherein said stream is known to be associated with the specific driver, to yield a trained model.

18. The method according to claim 17, wherein said detecting of the event of change of ownership of said specific driver from said specific vehicle, by applying a steam of said driver parameters to the trained model, wherein it is unknown whether said steam is associated with the specific driver.

19. A system for detecting a change of ownership in a connected vehicle, the method comprising:
a records processing module implemented on a computer processor configured to obtain, from a plurality of data sources, a plurality of automotive data records associated with connected vehicles associated with respective drivers; and
a change of ownership module implemented on said computer processor, configured to:
create, responsive to an explicit indication of an association of a specific driver of the respective drivers, with a specific connected vehicle of the connected vehicles, a unique driver profile comprising driver parameters being a subset of the automotive data records that are associated with an identifier of said specific driver;
learn, over a training stage, values of said driver parameters representative of said specific driver; and
detect an event of change of ownership of said specific driver of said specific vehicle, by monitoring values of said driver parameters of said specific driver over time and comparing the values of said driver parameters to the values of said driver parameters obtained by said learning, in view of predefined change of ownership criteria.

20. A non-transitory computer readable medium for detecting a change of ownership in a connected vehicle, the computer readable medium comprising a set of instructions that when executed cause at least one computer processor to:
obtain, from a plurality of data sources, a plurality of automotive data records associated with connected vehicles associated with respective drivers;
create, responsive to an explicit indication of an association of a specific driver of the respective drivers, with a specific connected vehicle of the connected vehicles, a unique driver profile comprising driver parameters being a subset of the automotive data records that are associated with an identifier of said specific driver;
learn, over a training stage, values of said driver parameters representative of said specific driver; and
detect an event of change of ownership of said specific driver of said specific vehicle, by monitoring values of said driver parameters of said specific driver over time, and comparing the values of said driver parameters to the values of said driver parameters obtained by said learning, in view of predefined change of ownership criteria.
